(19) United States
(12) Patent Application Publication
(10) Pub. No.: US 2025/0147184 A1
(43) Pub. Date: May 8, 2025

(54) GRAYSCALE IMAGE GENERATION DEVICE, GRAYSCALE IMAGE CORRECTION METHOD, AND GRAYSCALE IMAGE CORRECTION PROGRAM

(71) Applicant: OMRON CORPORATION, Kyoto-shi, Kyoto (JP)

(72) Inventors: Hideki CHUJO, Kyoto-shi (JP); Takashi KAKIUCHI, Kyoto-shi (JP); Hiroyuki TANAKA, Kyoto-shi (JP)

(73) Assignee: OMRON CORPORATION, Kyoto-shi, Kyoto (JP)

(21) Appl. No.: 18/261,678

(22) PCT Filed: Jan. 17, 2022
(86) PCT No.: PCT/JP2022/001258

§ 371 Date: Jan. 15, 2025

(30) Foreign Application Priority Data
Feb. 12, 2021 (JP) 2021-021134

(51) Int. Cl. G01S 17/86; G01S 7/497; G01S 17/894

(52) U.S. Cl. CPC G01S 17/86; G01S 7/497; G01S 17/894

(57) ABSTRACT

A grayscale image generation device (30) comprises a distance information acquisition unit (11), a grayscale information acquisition unit (12), a correction unit (13), and an image generation unit (14). The distance information acquisition unit (11) acquires information about the distance to an object (40) according to the amount of reflection of electromagnetic waves with which the object is irradiated from a lighting device (21). The grayscale information acquisition unit (12) acquires grayscale information according to the amount of reflection of the electromagnetic waves emitted from the lighting device (21) and irradiating the object. The correction unit (13) corrects the grayscale information acquired by the grayscale information acquisition unit (12) on the basis of the distance information acquired by the distance information acquisition unit (11). The image generation unit (14) generates a grayscale image including information about the distance to the object (40) on the basis of the grayscale information corrected by the correction unit (13).

### TECHNICAL FIELD

The present invention relates to a grayscale image generation device with which a grayscale image is generated on the basis of the distance to an object measured by a TOF sensor or the like, for example, as well as to a grayscale image correction method and a grayscale image correction program.

TOF (time of flight) sensors, which measure the distance from an LED (light emitting diode) serving as a light source to a measurement object by receiving reflected light that was emitted toward the measurement object, have been used in recent years, for example.

With some of these TOF sensors, such as with an indirect TOF sensor, light modulated at a specific frequency is emitted from an LED toward the measurement object, and the distance to the measurement object is measured by measuring the flight time of the light until reception of the reflected light that has come back after being reflected by the measurement object.

For example, Patent Literature 1 discloses a range finder in which, in order to improve the convenience of secondary use of an image whose brightness has been adjusted by a ToF method, the level of the light reception signal for each phase is controlled according to distance information calculated on the basis of the light reception signal for each phase outputted by a light receiving unit for each phase, and an adjustment value for adjusting the level of an image signal is generated on the basis of the light reception signal for each phase controlled according to the calculation of the distance information.

### CITATION LIST

### Patent Literature

Patent Literature: JP-A 2020-148510

### SUMMARY

However, the following problem is encountered with the above-mentioned conventional range finder.

Since plenty of light is usually emitted with a range finder, the distance to be measured and a grayscale image can be obtained with high accuracy. However, for distant objects, the distance can be measured accurately so long as reflected light can be detected, but since the amount of reflected light that is detected is inversely proportional to the square of the distance, a grayscale image containing grayscale information corresponding to the amount of reflected light ends up looking dark.

This problem, that distant objects appear dark in a grayscale image, is not taken into account in the range finder discussed above, and has been difficult to solve this problem with ordinary HDR (high-dynamic range) correction or contrast correction.

### Technical Problem

It is an object of the present invention to provide a grayscale image generation device with which, in a grayscale image generated according to the distance to an object, distant objects are displayed clearly, as well as a grayscale image correction method and a grayscale image correction program.

### Solution to Problem

The grayscale image generation device according to the first invention comprises a distance information acquisition unit, a grayscale information acquisition unit, a correction unit, and an image generation unit. The distance information acquisition unit acquires information about the distance to an object according to the amount of reflection of electromagnetic waves with which the object is irradiated from a lighting device. The grayscale information acquisition unit acquires grayscale information according to the amount of reflection of the electromagnetic waves emitted from the lighting device and irradiating the object. The correction unit corrects the grayscale information acquired by the grayscale information acquisition unit on the basis of the distance information acquired by the distance information acquisition unit. The image generation unit generates a grayscale image including information about the distance to the object on the basis of the grayscale information corrected by the correction unit.

Here, for example, a grayscale image is generated by using grayscale information corrected in the direction in which the amount of reflection increases, in order to clearly display a distant object that would otherwise appear dark because the amount of reflection of detected electromagnetic waves is inversely proportional to the square of the distance, in a grayscale image such as an infrared image.

Here, the electromagnetic waves emitted from the lighting device include, for example, light as broadly defined (ultraviolet light, visible light, infrared light), X-rays and gamma rays with shorter wavelengths than light, and microwaves, broadcast radio waves (short wave, medium wave, long wave), ultrasonic waves, elastic waves, quantum waves, etc., that have longer wavelengths than light. Any of these may be used as long as their reflection is attenuated by the square of the distance.

The distance information acquisition unit is, for example, a TOF (time of flight) sensor, LiDAR (light detection and ranging), or an SC (structural camera).

The grayscale information acquisition unit is, for example, an infrared camera or an RGB camera.

The distance information acquisition unit and the grayscale information acquisition unit may be configured to detect the reflection of electromagnetic waves and calculate distance information and grayscale information, or may be configured to acquire distance information and grayscale information, respectively, from a distance sensor and an infrared camera or the like provided as an external device.

As a result, in generating a grayscale image, rather than displaying a distant object using grayscale information according to the amount of reflection, which is inversely proportional to the square of the distance, a distant object can be displayed on the basis of grayscale information corrected in the direction in which the amount of reflection increases according to the distance to the object.

As a result, a distant object can be clearly displayed in a grayscale image generated according to the distance to the object.

The grayscale image generation device according to the second invention is the grayscale image generation device according to the first invention, wherein the correction unit corrects the grayscale information by multiplying the grayscale information obtained by the grayscale information acquisition unit by the square of the distance obtained by the distance information acquisition unit.

Consequently, a grayscale image in which the contour, etc., of the image is clearly shown can be obtained by multiplying the grayscale information, which changes according to the amount of reflection of the electromagnetic waves with which the object is irradiated and is inversely proportional to the square of the distance, by the square of the distance.

The grayscale image generation device according to the third invention is the grayscale image generation device according to the first or second invention, wherein the distance information acquisition unit acquires the distance information for each pixel included in the grayscale image generated by the image generation unit.

Consequently, distance information is acquired for each pixel included in the grayscale image, which allows the grayscale information to be corrected for each pixel.

The grayscale image generation device according to the fourth invention is the grayscale image generation device according to any of the first to third inventions, wherein the grayscale information acquisition unit acquires the grayscale information for each pixel included in the grayscale image generated by the grayscale image generation unit.

Consequently, the grayscale information is acquired for each pixel included in the grayscale image, which allows the grayscale information to be corrected on the basis of the distance information acquired for each pixel.

The grayscale image generation device according to the fifth invention is the grayscale image generation device according to any of the first to fourth inventions, wherein the correction unit uses the distance information acquired by the distance information acquisition unit to correct the grayscale information acquired by the grayscale information acquisition unit for each pixel included in the grayscale image generated by the grayscale image generation unit.

Consequently, the grayscale information is corrected on the basis of the distance information acquired for each pixel included in the grayscale image, which allows a grayscale image to be obtained in which a distant object is clearly displayed.

The grayscale image generation device according to the sixth invention is the grayscale image generation device according to any of the first to fifth inventions, wherein when the center position between the distance information acquisition unit and the lighting device and the center position between the grayscale information acquisition unit and the lighting device are located apart from each other, the correction unit corrects the distance information by subjecting the distance as seen from the grayscale information acquisition unit to coordinate transformation according to the positional relation between the distance information acquisition unit and the grayscale information acquisition unit.

Consequently, the distance information is corrected by coordinate conversion performed according to the relative positions of the distance information acquisition unit and the grayscale information acquisition unit, which allows a more accurate grayscale image to be obtained.

The grayscale image generation device according to the seventh invention is the grayscale image generation device according to any of the first to sixth inventions, wherein the distance information acquisition unit and the grayscale information acquisition unit are provided integrally.

Consequently, because the distance information acquisition unit and the grayscale information acquisition unit are provided integrally, a more accurate grayscale image can be obtained without performing the above-mentioned coordinate conversion or the like.

The grayscale image generation device according to the eighth invention is the grayscale image generation device according to any of the first to seventh inventions, further comprising a lighting control unit that controls the lighting device so as to irradiate the object with the electromagnetic waves.

Consequently, electromagnetic waves can be emitted under optimum irradiation conditions according to various conditions such as the distance to the object, shape, color, and so on.

The grayscale image generation device according to the ninth invention is the grayscale image generation device according to any of the first to eighth inventions, wherein the distance information acquisition unit acquires the distance information measured by a TOF (time of flight) sensor, LiDAR (light detection and ranging), or SC (structural camera).

This allows information about the distance to an object to be acquired using a TOF (time of flight) sensor, LiDAR (light detection and ranging), or an SC (structural camera).

The grayscale image generation device according to the tenth invention is the grayscale image generation device according to any of the first to ninth inventions, wherein the grayscale information acquisition unit acquires the grayscale information measured by an infrared camera or an RGB camera.

Consequently, the grayscale information included in the grayscale image can be acquired by using an infrared camera or an RGB camera as the grayscale information acquisition unit.

A grayscale image correction method according to the eleventh invention comprises a distance information acquisition step, a grayscale information acquisition step, a correction step, and an image generation step. The distance information acquisition step involves acquiring information about the distance to an object according to the amount of reflection of electromagnetic waves with which the object is irradiated from a lighting device. The grayscale information acquisition step involves acquiring grayscale information according to the amount of reflection of the electromagnetic waves emitted from the lighting device and irradiating the object. The correction step involves correcting the grayscale information acquired in the grayscale information acquisition step based on the distance obtained in the distance information acquisition step. The image generation step involves generating a grayscale image on the basis of the grayscale information corrected in the correction step.

Here, a grayscale image is generated using grayscale information corrected in the direction in which the amount of reflection increases, in order to clearly display a distant object that would otherwise look dark because the amount of reflection of detected electromagnetic waves is inversely proportional to the square of the distance in a grayscale image such as an infrared image, for example.

Here, the electromagnetic waves emitted from the lighting device include, for example, light as broadly defined (ultraviolet light, visible light, infrared light), X-rays and gamma rays with shorter wavelengths than light, and microwaves, broadcast radio waves (short wave, medium wave, long wave), ultrasonic waves, elastic waves, quantum waves, etc., that have longer wavelengths than light. Any of these may be used as long as their reflection is attenuated by the square of the distance.

The distance information acquisition step is carried out by using, for example, a TOF (time of flight) sensor, LiDAR (light detection and ranging), or an SC (structural camera).

The grayscale information acquisition step is carried out by using, for example, an infrared camera or an RGB camera.

The acquisition of distance information and the acquisition of grayscale information may be accomplished by detecting the reflection of electromagnetic waves and calculating distance information and grayscale information, or distance information and grayscale information may be respectively acquired from a distance sensor and an infrared camera or the like provided as an external device.

As a result, in generating a grayscale image, rather than displaying a distant object using grayscale information according to the amount of reflection, which is inversely proportional to the square of the distance, a distant object can be displayed on the basis of grayscale information corrected in the direction in which the amount of reflection increases according to the distance to the object.

As a result, a distant object can be clearly displayed in a grayscale image generated according to the distance to the object.

A grayscale image correction program according to the twelfth invention causes a computer to execute a grayscale image correction method comprising a distance information acquisition step, a grayscale information acquisition step, a correction step, and an image generation step. The distance information acquisition step involves acquiring information about the distance to an object according to the amount of reflection of electromagnetic waves with which the object is irradiated from a lighting device. The grayscale information acquisition step involves acquiring grayscale information according to the amount of reflection of the electromagnetic waves emitted from the lighting device and irradiating the object. The correction step involves correcting the grayscale information acquired in the grayscale information acquisition step on the basis of the distance obtained in the distance information acquisition step. The image generation step involves generating a grayscale image on the basis of the grayscale information corrected in the correction step.

Here, for example, a grayscale image is generated by using grayscale information corrected in the direction in which the amount of reflection increases, in order to clearly display a distant object that would otherwise appear dark because the amount of reflection of detected electromagnetic waves is inversely proportional to the square of the distance, in a grayscale image such as an infrared image.

Here, the electromagnetic waves emitted from the lighting device include, for example, light as broadly defined (ultraviolet light, visible light, infrared light), X-rays and gamma rays with shorter wavelengths than light, and microwaves, broadcast radio waves (short wave, medium wave, long wave), ultrasonic waves, elastic waves, quantum waves, etc., that have longer wavelengths than light. Any of these may be used as long as their reflection is attenuated by the square of the distance.

The distance information acquisition step is carried out by using a TOF (time of flight) sensor, LiDAR (light detection and ranging), or an SC (structural camera), for example.

The grayscale information acquisition step is carried out by using an infrared camera or an RGB camera, for example.

The acquisition of distance information and the acquisition of grayscale information may be accomplished by detecting the reflection of electromagnetic waves and calculating distance information and grayscale information, or distance information and grayscale information may be respectively acquired from a distance sensor and an infrared camera or the like provided as an external device.

As a result, in generating a grayscale image, rather than displaying a distant object using grayscale information according to the amount of reflection, which is inversely proportional to the square of the distance, a distant object can be displayed on the basis of grayscale information corrected in the direction in which the amount of reflection increases according to the distance to the object.

As a result, a distant object can be clearly displayed in a grayscale image generated according to the distance to the object.

### Effects

With the grayscale image generation device of the present invention, a distant object can be clearly displayed in a grayscale image generated according to the distance to the object.

### BRIEF DESCRIPTION OF THE DRAWINGS

FIG. 1 is an oblique view of the external configuration of the grayscale image generation device according to an embodiment of the present invention;

FIG. 2 is a control block diagram of the grayscale image generation device in FIG. 1;

FIG. 3 is a diagram of the control blocks formed in the grayscale image generation unit of the grayscale image generation device in FIG. 2;

FIG. 4 is a diagram illustrating the principle of calculating the distance to an object with a TOF sensor included in the grayscale image generation device in FIG. 2;

FIG. 5A is a diagram of a grayscale image before correction with the grayscale image generation device in FIG. 1 (as a comparative example), and FIG. 5B is a diagram of the grayscale image after correction with the grayscale image generation device in FIG. 1;

FIG. 6A is a diagram of a grayscale image before correction with the grayscale image generation device in FIG. 1 (as a comparative example), and FIG. 6B is a diagram of the grayscale image after correction by the grayscale image generation device in FIG. 1;

FIG. 7 is a flowchart showing the flow of processing in a grayscale image correction method featuring the grayscale image generation device in FIG. 1; and

FIG. 8 is a schematic diagram of the configuration of a grayscale image generation device according to another embodiment of the present invention.

### DESCRIPTION OF EMBODIMENTS

### Embodiment 1

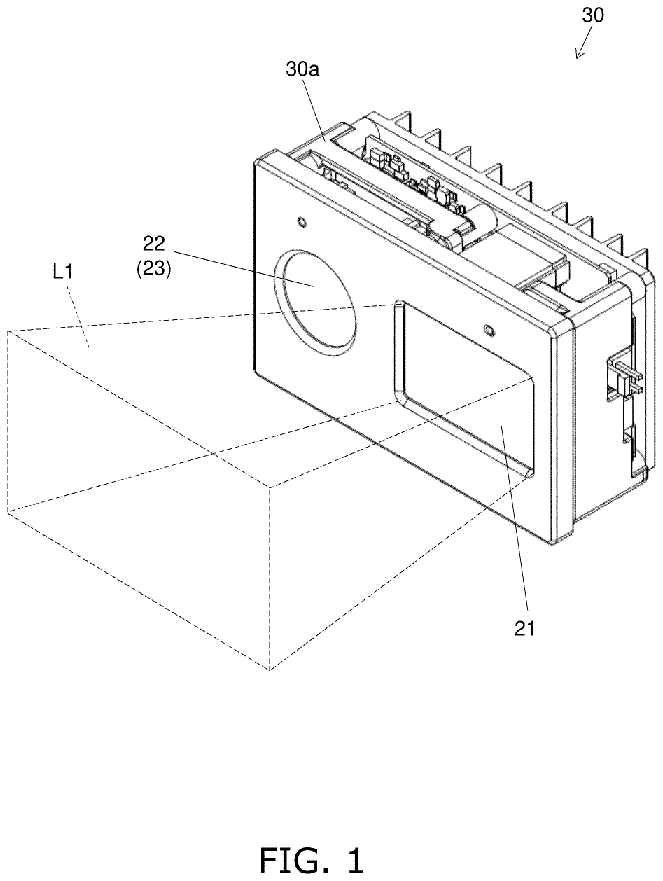

A grayscale image generation device 30 including a TOF sensor 20 according to an embodiment of the present invention will now be described with reference to FIGS. 1 to 7.

### (1) Configuration of Grayscale Image Generation Device 30

As shown in FIG. 1, the grayscale image generation device 30 according to this embodiment is configured such that reflected light L1 (an example of electromagnetic waves) that was emitted from a lighting device 21 provided on the front of a main body 30a toward an object 40 is received by an imaging element 23 via a light receiving lens 22, and a grayscale image is generated that includes distance information and grayscale information according to the time of flight of the light from the time the light L1 is emitted until it is received.

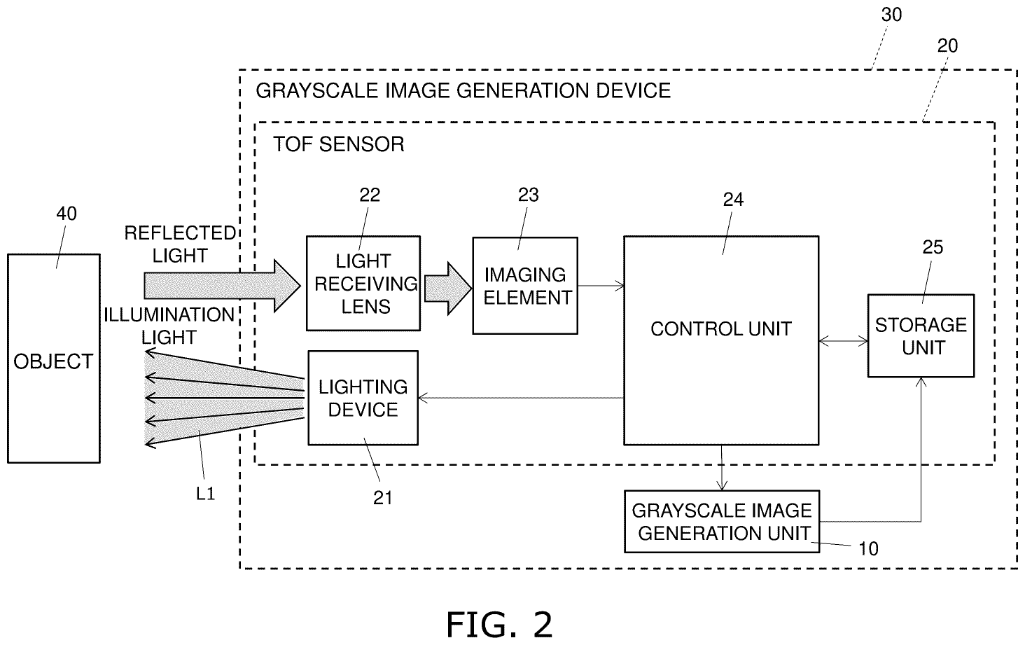

As shown in FIG. 2, the grayscale image generation device 30 internally comprises the grayscale image generation unit 10 and the TOF sensor 20.

As shown in FIG. 2, the grayscale image generation unit 10 is connected to a control unit 24 of the TOF sensor 20, acquires information about the distance to the object as measured by the TOF sensor 20 and grayscale information, and generates a grayscale image (such as an infrared image). The configuration of the grayscale image generation unit 10 will be described in detail below.

As shown in FIG. 2, the TOF sensor 20 comprises the lighting device 21, the light receiving lens 22, the imaging element 23, the control unit (lighting control unit) 24, and a storage unit 25.

The lighting device 21 has an LED, for example, and irradiates the object 40 with light of the desired wavelength. The lighting device 21 is provided with a projection lens (not shown) that collects the light emitted from the LED and guides it toward the object 40.

The light receiving lens 22 is provided in order to receive light that was emitted from the lighting device 21 and reflected by the object 40 and guide this light to the imaging element 23.

The imaging element 23 has a plurality of pixels, and is configured such that reflected light received by the light receiving lens 22 is received for each of the plurality of pixels, and transmits an electrical signal obtained by photoelectric conversion to the control unit 24. An electrical signal corresponding to the received amount of reflected light sensed by the imaging element 23 is used by the control unit 24 to calculate distance information and grayscale information.

The control unit 24 is connected to the lighting device 21, the imaging element 23, and the storage unit 25, as shown in FIG. 2. The control unit 24 then reads a lighting control program stored in the storage unit 25 to control the lighting device 21, which irradiates the object 40 with light. More precisely, the control unit 24 controls the lighting device 21 so as to emit the optimal amount of light as dictated by the distance to the object 40 to be irradiated with light, the shape, color, and other such properties of the object, etc. The control unit 24 also calculates information about the distance to the object and grayscale information (such as luminance information), for each pixel, on the basis of the electrical signal corresponding to each pixel received from the imaging element 23.

The principle of measuring the distance to the object 40 used by the TOF sensor 20 will be discussed in detail below.

As shown in FIG. 2, the storage unit 25 is connected to the control unit 24, and stores a control program for controlling the lighting device 21 and the imaging element 23, the amount of reflected light sensed by the imaging element 23, the light reception timing, and distance information and grayscale information calculated on the basis of amount of reflected light. Also, the storage unit 25 is connected to the grayscale image generation unit 10 as shown in FIG. 2, and stores data about the grayscale image generated by the grayscale image generation unit 10 and about the corrected grayscale image.

### (2) Configuration of Grayscale Image Generation Unit 10

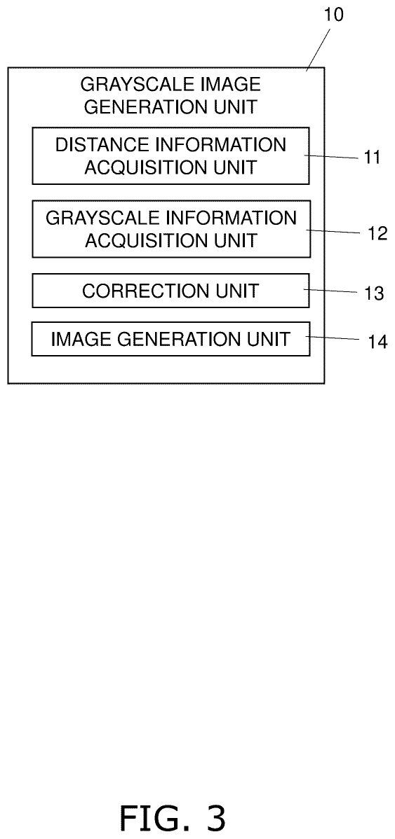

As shown in FIG. 3, the grayscale image generation unit 10 comprises a distance information acquisition unit 11, a grayscale information acquisition unit 12, a correction unit 13, and an image generation unit 14.

The distance information acquisition unit 11 acquires from the control unit 24 of the TOF sensor 20 information about the distance to the object 40 corresponding to each pixel of the grayscale image captured by the imaging element 23.

The grayscale information acquisition unit 12 acquires grayscale information (luminance information) corresponding to each pixel constituting a grayscale image including the object 40 captured by the imaging element 23, from the control unit 24 of the TOF sensor 20.

The correction unit 13 corrects the grayscale information for each pixel constituting the grayscale image acquired by the grayscale information acquisition unit 12, on the basis of the distance information acquired by the distance information acquisition unit 11.

The image generation unit 14 uses the grayscale information corrected by the correction unit 13 to generate a grayscale image.

### Principle of Distance Measurement by TOF Sensor 20

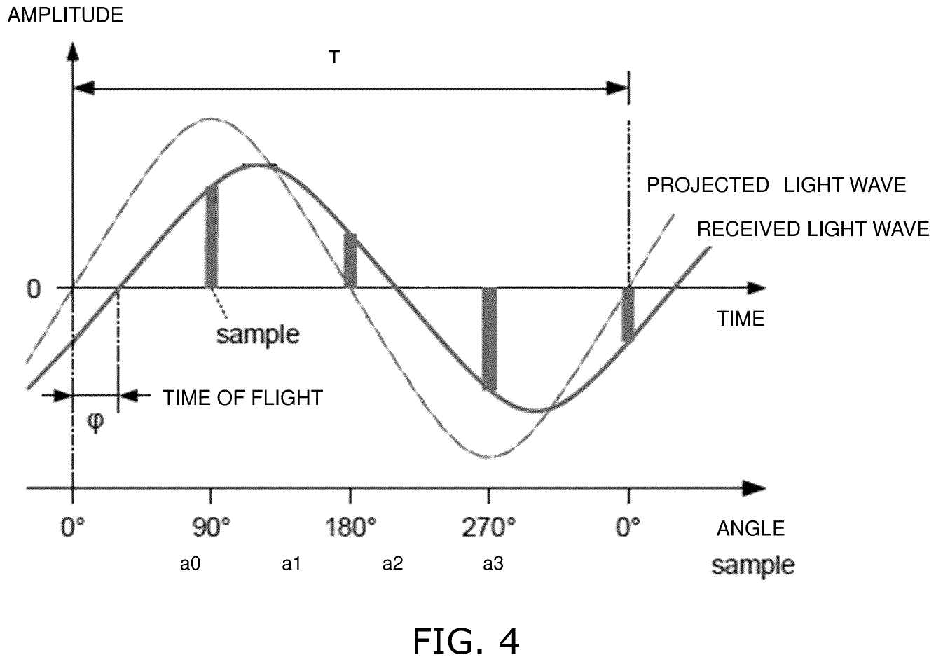

The principle of measuring the distance to an object with the TOF sensor 20 in this embodiment will now be described with reference to FIG. 4.

Specifically, in this embodiment, the control unit 24 of the TOF sensor 20 calculates the distance to the object 40 on the basis of the phase difference Φ (see FIG. 4) between the projected wave of light emitted from the lighting device 21 and the received wave of light received by the imaging element 23.

Here, the phase difference Φ is expressed by the following relational formula (1).

$$Φ = atan ( y / x ) \qquad ( 1 )$$

(where x=a2−a0, y=a3−a1, and a0 to a3 are the amplitudes at the points where the received wave was sampled four times at intervals of 90 degrees)

A conversion formula from the phase difference Φ to the distance D is given by the following relational formula (2).

$$D = ( c / ( 2 \times {f}_{LED} ) ) \times ( Φ / 2 π ) + {D}_{OFFSET} \qquad ( 2 )$$

(where c is the speed of light (˜3×10⁸ m/s), f_{LED} is the frequency of the LED projection wave, and D_{OFFSET} is the distance offset)

Consequently, the reflected part of the light emitted from the lighting device 21 is received, and the phase difference thereof is compared, which allows the distance to the object 40 to be easily calculated using the speed of light c.

### Correction of Grayscale Image

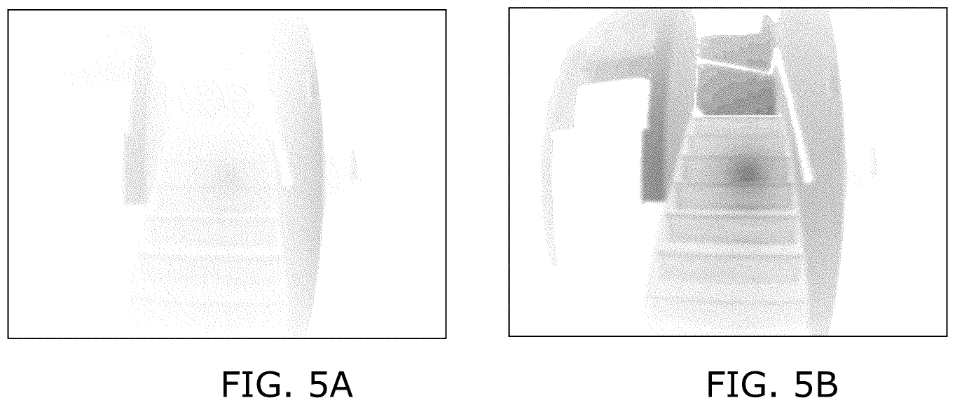

Here, the image generation unit 14 that generates a corrected grayscale image on the basis of the distance information corresponding to each pixel generates the grayscale image shown in FIG. 5B as a result of correction of the grayscale information by the correction unit 13.

FIGS. 5A and 5B show an image of a stairway in which a handrail has been installed.

In the grayscale image shown in FIG. 5B, the portion of the stairway that is farther away (as seen from the grayscale image generation device 30), as well as the handrail, wall surfaces, etc., are more clearly visible than the uncorrected grayscale image shown in FIG. 5A (comparative example).

Consequently, as the distance to the object increases, the amount of reflected light attenuates in inverse proportion to the square of the distance, which prevents the contour, etc., of a distant object from appearing indistinct, and allows a grayscale image to be obtained that can clearly show even a distant object.

The corrected grayscale image generated by the image generation unit 14 is combined with a distance image generated using the distance information measured by the TOF sensor 20, for example, and is used for human body detection, human face detection, and so forth.

Also, the corrected grayscale image generated by the image generation unit 14 may be outputted to the outside as a grayscale image for use in various kinds of determination.

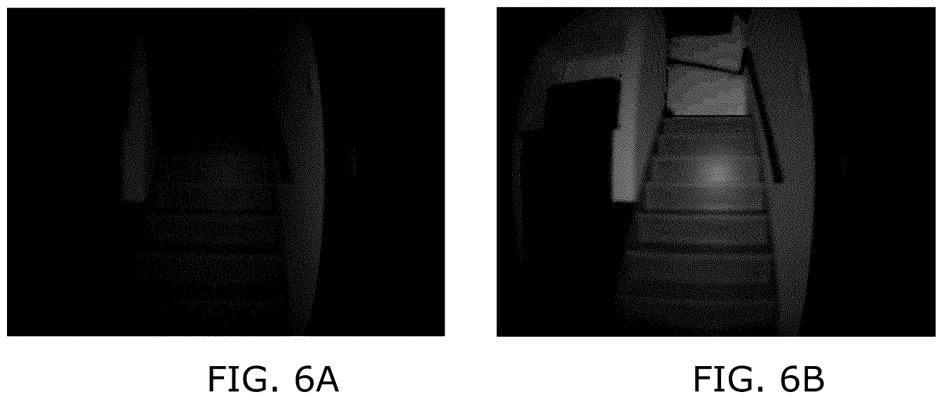

Furthermore, the grayscale image generated by the image generation unit 14 may be an infrared image in which the black and white shown in FIGS. 5A and 5B are reversed as shown in FIGS. 6A and 6B.

### Gray Scale Image Correction Method

The grayscale image generation device 30 of this embodiment generates a grayscale image in which the grayscale information (luminance) in a grayscale image has been corrected by the following correction processing.

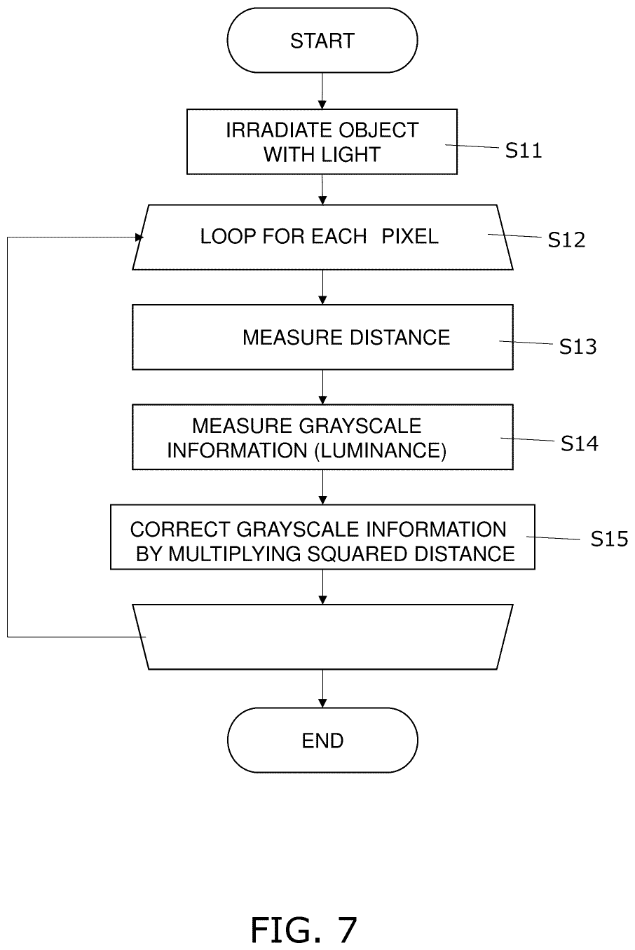

That is, as shown in the flowchart of FIG. 7, in step S11, the control unit 24 of the TOF sensor 20 controls the lighting device 21 so as to irradiate the object 40 with a specific light.

Next, in step S12, the processing from steps S13 to S15 are repeatedly executed for each pixel included in the grayscale image captured by the imaging element 23 until the processing is complete for all the pixels.

Next, in step S13, the information about the distance to the object is measured for each corresponding pixel under the measurement principle of the TOF sensor 20 discussed above, and the distance information acquisition unit 11 of the grayscale image generation unit 10 acquires this.

Next, in step S14, the grayscale information (brightness information) about the object is measured for each corresponding pixel in the image captured by the imaging element 23, and the grayscale information acquisition unit 12 of the grayscale image generation unit 10 acquires this.

Next, in step S15, the corrected grayscale information (luminance) is calculated by multiplying the grayscale information (luminance) acquired in step S14 by the square of the distance information acquired in step S13.

The processing from steps S12 to S15 is performed for all of the pixels, and then the processing is ended.

Here, the method for correcting the grayscale image will be described in further detail as follows.

Specifically, with the grayscale image generation device 30 of this embodiment, point group information represented by the three axes of XYZ and a grayscale image (infrared gray image) of QVGA (quarter VGA) are acquired by the imaging element 23 of the TOF sensor 20.

The point group information corresponds to the various points of the QVGA. Accordingly, the correction unit 13 corrects the grayscale information (luminance value) of the infrared gray image by using the point group information.

If we let x (n), y (n), and z (n) be the XYZ coordinates of each point, let dist be the distance to be standardized, and let L_{org}(n) be the luminance value before correction, the corrected luminance value L_{correct}(n) is calculated by the following relational formula (3).

$$[ First Mathematical Formula ]$$

$${L}_{correct} ( n ) = {L}_{org} ( n ) \times \frac{{x ( n )}^{2} + {y ( n )}^{2} + {z ( n )}^{2}}{{dist}^{2}} \qquad ( 3 )$$

For example, when calculating in meter units and correcting the distance to 1 m, the above relational formula (3) is simplified and shown as the following relational formula (4).

$$[ Second Mathematical Formula ]$$

$${L}_{c orrect} ( n ) = {L}_{org} ( n ) \times \{ {x ( n )}^{2} + {y ( n )}^{2} + {z ( n )}^{2} \} \qquad ( 4 )$$

When the distance information is represented by point group information of the three axes of XYZ, it is as described above, but when distance information (depth information) about the polar coordinate system is obtained directly, in the case of correction to a distance of 1 m, the above relational formula (3) is further simplified and shown as the following relational formula (5).

$$[ Third Mathematical Formula ]$$

$${L}_{correct} ( n ) = {L}_{org} ( n ) \times {Depth ( n )}^{2} \qquad ( 5 )$$

The light emitted from the lighting device 21 is reflected by the object 40 and detected as reflected light that has been attenuated in inverse proportion to the square of the distance from the sensor to the object (double the distance if the distance of the reflected light is also taken into account).

Therefore, in this embodiment, correction is performed so as to obtain a grayscale image that is less affected by this attenuation of reflected light, by multiplying the grayscale information acquired by the grayscale information acquisition unit 12 by the square of the distance to the object 40 acquired by the distance information acquisition unit 11.

Consequently, a grayscale image in which even objects that are far away appear clearly is generated, as shown in FIG. 5B or FIG. 6B, by correction in which the grayscale information (luminance) corresponding to the amount of reflected light, which is attenuated in inverse proportion to the square of the distance, is multiplied by the square of the distance.

### Embodiment 2

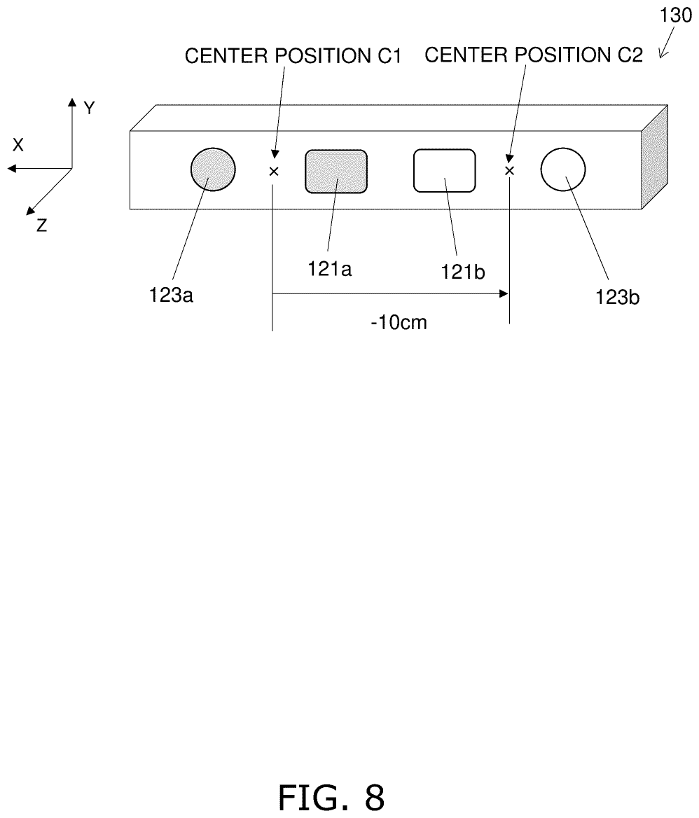

The grayscale image generation device 130 according to another embodiment of the present invention will now be described with reference to FIG. 8.

As shown in FIG. 8, the grayscale image generation device 130 of this embodiment differs from Embodiment 1 above, in which the single lighting device 21 and the imaging element 23 were used to acquire distance information and grayscale information, in that lighting devices 121a and 121b that irradiate the object 40 with light are provided in order to acquire distance information and grayscale information, respectively, and that light-receiving units 123a and 123b for detecting this reflected light are provided separately.

That is, in this embodiment, the lighting device 121a and the light receiving unit 123a for acquiring distance information, and the lighting device 121b and the light receiving unit 123b for acquiring grayscale information are provided separately.

Here, when a device for acquiring distance information and a device for acquiring grayscale information are disposed at positions apart from each other as independent devices, the information about the distance from the device for acquiring distance information to a specific object will not match the information about the distance from the device for acquiring grayscale information to the object.

Accordingly, in order to perform precise correction, it is necessary to use information about the distance from the device for acquiring grayscale information to the object.

With the grayscale image generation device 130 in this embodiment, since the offset in the installation positions between the device for acquiring distance information and the device for acquiring grayscale information is known (by design), the distance information is corrected according to the amount of offset in the installation positions.

For example, as shown in FIG. 8, let us assume that in a state in which the optical axes are substantially parallel to each other, the center position C2 of the device for acquiring grayscale information is installed at a position that is −10 cm away from the center position C1 of the device for acquiring distance information in the X axis direction.

The center position C1 is set as the center position of the device for acquiring distance information (the lighting device 121a and the light receiving unit 123a). The center position C2 is set as the center position of the device for acquiring grayscale information (the lighting device 121b and the light receiving unit 123b).

In this case, the above relational formulas (3) and (4) are subjected to coordinate transformation based on the center position C1 of the device that acquires distance information and the center position C2 of the device that acquires grayscale information, and are shown as the following formulas (3′) and (4′), respectively.

$$[ Fourth Mathematical Formula ]$$

$${L}_{correct} ( n ) = {L}_{o r g} ( n ) \times \frac{{\{ x ( n ) - 0.1 \}}^{2} + {y ( n )}^{2} + {z ( n )}^{2}}{{dist}^{2}} \qquad ( 3 )$$

$$[ Fifth Mathematical Formula ]$$

$${L}_{correct} ( n ) = {L}_{org} ( n ) \times [ {\{ x ( n ) - 0.1 \}}^{2} + {y ( n )}^{2} + {z ( n )}^{2} ] \qquad ( {4}^{′} )$$

Consequently, even if the center position C1 of the device that acquires distance information and the center position C2 of the device that acquires grayscale information are disposed at positions that are away from each other, the positional deviation between the devices can be corrected by coordinate transformation, allowing the same effect as in the above embodiment to be obtained.

In the example shown in FIG. 8, an ordinary sensor configuration is assumed, but the configuration may instead be such that a single lighting device is use for both of the lighting devices used to acquire distance information and grayscale information. Alternatively, a single sensor may be used instead of the two sensors that are provided separately and receive the amount of reflected light.

In this case, the center position of the device, which serves as the reference for coordinate conversion, may be set at the center between the shared lighting device or light receiving unit and the other light receiving unit or lighting device.

As described above, even if the devices for acquiring the distance information and the grayscale information are provided at separate positions, as long as the amount of positional deviation between them is known, a highly accurate grayscale image that has been corrected according to the distance information can be obtained by adding coordinate transformation according to the positional deviation between the two to the correction method described in Embodiment 1 above.

### OTHER EMBODIMENTS

Embodiments of the present invention were described above, but the present invention is not limited to or by the above embodiments, and various modifications are possible without departing from the gist of the invention.

### (A)

In the above embodiments, examples of the present invention were given as a grayscale image generation device and a grayscale image correction method. However, the present invention is not limited to this.

For example, the present invention may be realized as a grayscale image correction program that causes a computer to execute a grayscale image correction method with the grayscale image generation device described above.

This grayscale image correction program is stored in a memory (storage unit) installed in the grayscale image generation device, and the CPU reads the grayscale image correction program stored in the memory and causes hardware to execute the various steps.

More specifically, the same effect as above can be obtained when the CPU reads the grayscale image correction program and executes the distance information acquisition step, the grayscale information acquisition step, the correction step, and the image generation step.

Also, the present invention may be realized as a recording medium on which a grayscale image correction program is stored.

### (B)

In the above embodiments, an example was given in which the TOF sensor 20 was used to measure distance information corresponding to each of the pixels constituting a grayscale image. However, the present invention is not limited to this.

For example, the configuration may be such that distance information measured using some other means such as LiDAR (light detection and ranging) or an SC (structural camera) is transmitted to the grayscale image generation unit.

### (C)

In the above embodiments, an example was given in which the imaging element 23 was used to measure distance information and grayscale information corresponding to the various pixels constituting a grayscale image. However, the present invention is not limited to this.

For example, the configuration may be such that grayscale information measured using an infrared camera, an RGB camera, or the like is transmitted to the grayscale image generation unit.

### (D)

In the above embodiment, an example was given in which a grayscale image was generated using distance information and grayscale information measured by the imaging element 23 of the TOF sensor 20 included in the grayscale image generation device 30. However, the present invention is not limited to this.

For example, the grayscale image generation device may receive distance information and grayscale information from an external distance sensor such as a TOF sensor and a grayscale image sensor such as an infrared camera, respectively, and generate a grayscale image that has been corrected according to the distance information.

### (E)

In the above embodiments, an example was given in which the distance to the object was measured by detecting the reflected part of the light emitted from the lighting device 21 and irradiating the object. However, the present invention is not limited to this.

For example, the configuration may be such that the object is irradiated with X-rays or gamma rays with shorter wavelengths than light, or with microwaves, broadcast radio waves (short wave, medium wave, long wave), etc., that have longer wavelengths than light, from the lighting device, instead of with light as broadly defined (ultraviolet light, visible light, infrared light).

That is, the light with which the object is irradiated may be some other kind of electromagnetic waves having the property that the reflection amount is attenuated in inverse proportion to the square of the distance.

### (F)

In Embodiment 2 above, as shown in FIG. 8, an example was given in which devices for acquiring distance information and grayscale information were disposed so as to be offset in the X axis direction in the drawings. However, the present invention is not limited to this.

For example, the correction by coordinate transformation described in Embodiment 2 is not limited to positional deviation in the X axis direction, and may instead be positional deviation in the Y direction or the Z direction, and even if there is deviation in the three directions of the XYZ axes, the above-mentioned relational formula (4′) can be used to do the same thing.

Furthermore, even with a configuration in which the offset is in rotation, that is, the measurement direction (optical axis, etc.) of the distance information and the grayscale information acquisition means, rather than positional deviation due to parallel movement, the present invention can still be applied by subjecting position information in space measured by the distance information acquisition means to rotational transformation, and finding the distance information as seen from the grayscale information acquiring means.

### (G)

In Embodiment 2 above, as shown in FIG. 8, an example was given in which two devices for acquiring distance information and grayscale information were disposed in the same housing. However, the present invention is not limited to this.

For example, two devices for acquiring distance information and grayscale information may be provided independently in separate housings.

Here again, as long as the amount of positional deviation between the devices is known, the same effect as in Embodiment 2 above can be obtained by correction processing including coordinate transformation, as in Embodiment 2 above.

### INDUSTRIAL APPLICABILITY

The grayscale image generation device of the present invention exhibits the effect of being able to clearly display a distant object in a grayscale image generated according to the distance to the object, and as such is widely applicable to a variety of sensors that make use of grayscale images.

### REFERENCE SIGNS LIST

10 grayscale image generation unit
11 distance information acquisition unit
12 grayscale information acquisition unit
13 correction unit
14 image generation unit
20 TOF sensor
21 lighting device
22 light receiving lens
23 imaging element
24 control unit (lighting control unit)
25 storage unit
30 grayscale image generation device
30a main body
40 object
121a, 121b lighting device
123a, 123b light receiving unit
130 grayscale image generation device
C1, C2 center position
D distance
L1 illumination light

1. A grayscale image generation device, comprising:
a distance information acquisition unit configured to acquire information about a distance to an object according to an amount of reflection of electromagnetic waves with which the object is irradiated from a lighting device;
a grayscale information acquisition unit configured to acquire grayscale information according to the amount of reflection of the electromagnetic waves emitted from the lighting device and irradiating the object;
a correction unit configured to correct the grayscale information obtained by the grayscale information acquisition unit on the basis of the distance obtained by the distance information acquisition unit; and
an image generation unit configured to generate a grayscale image including information about the distance to the object on the basis of the grayscale information corrected by the correction unit.

2. The grayscale image generation device according to claim 1,
wherein the correction unit corrects the grayscale information by multiplying the grayscale information obtained by the grayscale information acquisition unit by a square of the distance obtained by the distance information acquisition unit.

3. The grayscale image generation device according to claim 1 or 2,
wherein the distance information acquisition unit acquires the distance information for each pixel included in the grayscale image generated by the image generation unit.

4. The grayscale image generation device according to any of claims 1 to 3,
wherein the grayscale information acquisition unit acquires the grayscale information for each pixel included in the grayscale image generated by the image generation unit.

5. The grayscale image generation device according to any of claims 1 to 4,
wherein the correction unit uses the distance information acquired by the distance information acquisition unit to correct the grayscale information acquired by the grayscale information acquisition unit for each pixel included in the grayscale image generated by the image generation unit.

6. The grayscale image generation device according to any of claims 1 to 5,
wherein when a center position between the distance information acquisition unit and the lighting device and the center position between the grayscale information acquisition unit and the lighting device are located apart from each other,
the correction unit corrects the distance information by subjecting the distance as seen from the grayscale information acquisition unit to coordinate transformation according to a positional relation between the distance information acquisition unit and the grayscale information acquisition unit.

7. The grayscale image generation device according to any of claims 1 to 6,
wherein the distance information acquisition unit and the grayscale information acquisition unit are provided integrally.

8. The grayscale image generation device according to any of claims 1 to 7,
further comprising a lighting control unit configured to control the lighting device so as to irradiate the object with the electromagnetic waves.

9. The grayscale image generation device according to any of claims 1 to 8,
wherein the distance information acquisition unit acquires the distance information measured by a TOF (time of flight) sensor, LiDAR (light detection and ranging), or SC (structural camera).

10. The grayscale image generation device according to any of claims 1 to 9,
wherein the grayscale information acquisition unit acquires the grayscale information measured by an infrared camera or an RGB camera.

11. A grayscale image correction method, comprising:
a distance information acquisition step of acquiring information about a distance to an object according to an amount of reflection of electromagnetic waves with which the object is irradiated from a lighting device;
a grayscale information acquisition step of acquiring grayscale information according to the amount of reflection of the electromagnetic waves emitted from a lighting device and irradiating the object;
a correction step of correcting the grayscale information acquired in the grayscale information acquisition step based on the distance obtained in the distance information acquisition step; and
an image generation step of generating a grayscale image on the basis of the grayscale information corrected in the correction step.

12. A grayscale image correction program for causing a computer to execute a grayscale image correction method comprising:
a distance information acquisition step of acquiring information about a distance to an object according to an amount of reflection of electromagnetic waves with which the object is irradiated from a lighting device;
a grayscale information acquisition step of acquiring grayscale information according to the amount of reflection of the electromagnetic waves emitted from a lighting device and irradiating the object;
a correction step of correcting the grayscale information acquired in the grayscale information acquisition step on the basis of the distance obtained in the distance information acquisition step; and
an image generation step of generating a grayscale image on the basis of the grayscale information corrected in the correction step.
